(19) United States
(12) Patent Application Publication
(10) Pub. No.: US 2026/0034597 A1
(43) Pub. Date: Feb. 5, 2026

(54) WIRE ELECTRICAL DISCHARGE MACHINING EQUIPMENT FOR DIFFERENT WORKPIECE HEIGHTS

(71) Applicants: NATIONAL TAIWAN NORMAL UNIVERSITY, Taipei City (TW); ACCUTEX TECHNOLOGIES CO., LTD, Taichung City (TW)

(72) Inventors: Shun-Tong Chen, Taipei City (TW); Guan-Wei Chen, Taipei City (TW); Pin-Yun Chen, Taipei City (TW); Hua-Yu Tseng, Taichung City (TW); Chen-Fu Tsai, Taichung City (TW)

(21) Appl. No.: 19/276,847

(22) Filed: Jul. 22, 2025

(30) Foreign Application Priority Data
Aug. 2, 2024 (TW) 113129061

(51) Int. Cl. B23H 1/00; G05B 19/408

(52) U.S. Cl. CPC B23H 1/00; G05B 19/4083; G05B 2219/45221

(57) ABSTRACT

A wire electrical discharge machining equipment for different workpiece heights comprises a wire electrode, a machining detecting device and a controller. The wire electrode has an electrode length and is configured to machine a workpiece. The machining detecting device is configured to detect and obtain a machining parameter set of the wire electrode while machining the workpiece. Wherein, the machining parameter set comprises a discharge frequency, a working voltage and a discharge parameter, and the discharge parameter is corresponding to a material removal amount. The controller is connected to the wire electrode and the machining detecting device. The controller is configured to compute a workpiece height of the workpiece according to the discharge frequency and the working voltage, and compute a machining feed rate according to the workpiece height and the material removal amount. The controller is configured to adjust the electrode length to the workpiece height and controls the wire electrode to machine the workpiece with the machining feed rate.

### BACKGROUND OF THE INVENTION

### 1. Field of the Invention

The present invention relates to the field of electrical discharge machining, and more particularly, to a wire electrical discharge machining equipment adjusting an electrode length and a machining feed rate for different workpiece heights.

### 2. Description of the Prior Art

In recent years, with the advancement in technologies related to semiconductors, electronics and machinery, micro-products have been moving toward miniaturization and precision design. These micro-products are manufactured using high-precision tooling in the aerospace, automotive, medical and electronics fields. In general, the materials used for high-precision tooling are selected for their hardness and high intensity, such as SKD-11. Due to the high mechanical strength and complex structure of the high-precision tooling, it is typically machined using CNC wire-cut electrical discharge machines.

In the machining process, workpiece or tooling can undergo the first rough cut machining to remove large amount of unnecessary material, and then they can be adjusted to match the target structure by finish machining. However, with the miniaturization and precision design of the products, workpieces may have varying heights and shapes. Using the same discharge parameters and feed rate under the conditions with different workpiece heights and shapes can lead to over-machining, thereby reducing machining stability and machining quality and increasing machining time due to the energy limitations. Therefore, machining parameters should be adjusted according to the height and shape of the workpiece at different locations. In prior art, the finish machining of the workpieces with varying heights and shapes requires the manual adjustment of machining parameters, which not only increases labor and machining time costs but also reduces machining efficiency.

Therefore, there is an urgent need to develop a novel electrical discharge machining equipment to solve the problems of the prior art.

### SUMMARY OF THE INVENTION

In one specific embodiment of the present invention, the wire electrical discharge machining equipment for different workpiece heights comprises a wire electrode, a machining detecting device and a controller. The wire electrode has an electrode length and is configured to machine a workpiece. The machining detecting device is configured to detect and obtain a machining parameter set of the wire electrode while machining the workpiece. Wherein, the machining parameter set comprises a discharge frequency, a working voltage and a discharge parameter, and the discharge parameter is corresponding to a material removal amount. The controller is connected to the wire electrode and the machining detecting device. The controller is configured to compute a workpiece height of the workpiece according to the discharge frequency and the working voltage, and compute a machining feed rate according to the workpiece height and the material removal amount. The controller is configured to adjust the electrode length to the workpiece height and controls the wire electrode to machine the workpiece with the machining feed rate.

Wherein, the controller computes the workpiece height according to the following equation:

$${H}_{h} = {Z}_{0} + {X}_{B} \times {e}^{- 0.5 {( \frac{ln ( {f}_{Norm} / {X}_{C} )}{{X}_{D}} )}^{2}} + {Y}_{B} \times {e}^{- 0.5 {( \frac{ln ( OV / {Y}_{C} )}{{Y}_{D}} )}^{2}} + {XY}_{H} \times {e}^{- 0.5 ( {( \frac{ln ( {f}_{Norm} / {X}_{C} )}{{X}_{D}} )}^{2} + {( \frac{ln ( OV / {Y}_{C} )}{{Y}_{D}} )}^{2} )}$$

Wherein, Hₕ is the workpiece height, f_{Norm} is the discharge frequency, OV is the working voltage, Z₀,X_{B},X_{C},X_{D},Y_{B},Y_{C},Y_{D} and X_{YH} are constants.

Wherein, the controller computes the machining feed rate according to the following equation:

$$F = {F}_{z 0} + {F}_{XY} \times {e}^{( \frac{- {H}_{h}}{{F}_{XC}} )} \times {e}^{( \frac{- SR}{{F}_{YC}} )}$$

Wherein, F is the machining feed rate, SR is the material removal amount, F_{z0},F_{XY},F_{XC} and F_{YC} are constants.

Wherein, the wire electrical discharge machining equipment further comprises a fixed electrode head and a movable electrode head for fixing both ends of the wire electrode respectively and being connected to the controller and the controller is configured to drive the movable electrode head to adjust the electrode length of the wire electrode.

Wherein, the workpiece has a bottom surface and a top surface. The location of the fixed electrode head and the movable electrode head are corresponding to the bottom surface and the top surface respectively, and the shape of the top surface is at least one of a flat surface, an inclined surface, a curved surface and a stepped surface.

The present invention provides a method for wire electrical discharge machining applied to different workpiece heights.

In one specific embodiment, the method for wire electrical discharge machining comprises the following steps of: detecting and obtaining a machining parameter set of the wire electrode while machining the workpiece by a machining detecting device, wherein the machining parameter set comprises a discharge frequency, a working voltage and a discharge parameter, and the discharge parameter is corresponding to a material removal amount; computing a workpiece height of the workpiece according to the discharge frequency and the working voltage by a controller; computing a machining feed rate according to the workpiece height and the material removal amount by the controller; and adjusting the electrode length to the workpiece height and controlling the wire electrode to machine the workpiece with the machining feed rate by the controller.

Wherein, the method for wire electrical discharge machining further comprises the steps of: setting a fixed electrode head and a movable electrode head to fix both ends of the wire electrode respectively, and setting the fixed electrode head and the movable electrode head to be corresponding to a bottom surface and a top surface respectively to machine the workpiece. Wherein, the step of adjusting the electrode length of the wire electrode further comprises the step of: driving the movement of the movable electrode head by the controller to adjust the electrode length of the wire electrode.

In summary, the invention of the wire electrical discharge machining equipment can detect the machining parameter of the electrode in real time according to the machining detecting device and automatically detect the workpiece height of the workpiece through a discharge parameter surface model. In addition, the invention of the wire electrical discharge machining equipment can automatically adjust the machining feed rate to the correct machining feed rate through a wire electrode feed rate surface model and receive real-time feedback to adjust the wire electrode length and the machining feed rate. Moreover, the wire electrical discharge machining equipment can remove the rough cutting residual materials from workpieces with different heights to increase machining accuracy and machining efficiency, and improve stability and machining quality.

### BRIEF DESCRIPTION OF THE APPENDED DRAWINGS

FIG. 1 is a functional block diagram illustrating the wire electrical discharge machining equipment according to an embodiment of the present invention.

FIG. 2 is a structural diagram illustrating the wire electrode and the workpiece according to an embodiment of the present invention.

FIG. 3 is a structural diagram from another perspective illustrating the wire electrode and the workpiece of FIG. 2.

FIG. 4A is a structural diagram illustrating that the wire electrode machines the workpiece at the first location according to an embodiment of the present invention.

FIG. 4B is a structural diagram from another perspective illustrating that the wire electrode machines the workpiece at the second location of FIG. 4A.

FIG. 5 is a flow chart illustrating the method for wire electrical discharge machining according to an embodiment of the present invention.

FIG. 6 is a flow chart illustrating the method for wire electrical discharge machining according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

The invention of the wire electrical discharge machining equipment for different workpieces can be applied to the precision or finishing machining stage. Specifically, the present invention can be used not only for the second finishing machining following the first rough cutting, but also for precision machining applications.

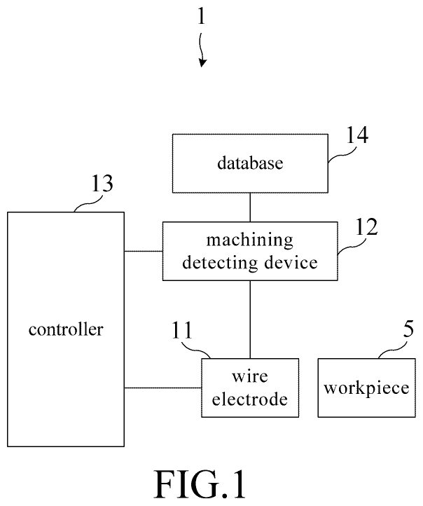

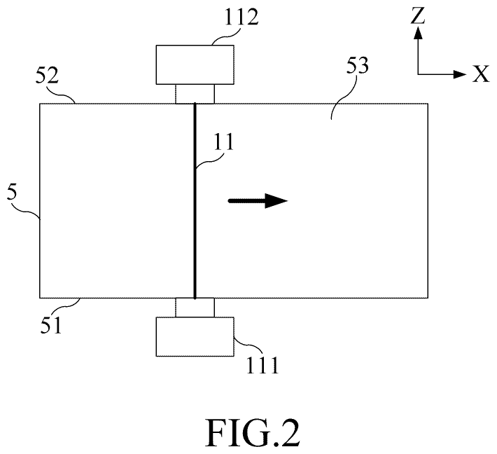

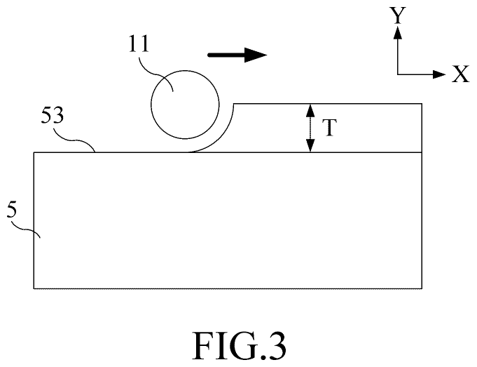

Please refer to FIG. 1, FIG. 2 and FIG. 3. FIG. 1 is a functional block diagram illustrating the wire electrical discharge machining equipment according to an embodiment of the present invention. FIG. 2 is a structural diagram illustrating the wire electrode and the workpiece according to an embodiment of the present invention. FIG. 2 illustrates the perspective in the X-Z plane. FIG. 3 is a structural diagram from another perspective illustrating the wire electrode and the workpiece of FIG. 2. As shown in FIG. 1, in this specific embodiment, the wire electrical discharge machining equipment 1 comprises a wire electrode 11, a machining detecting device 12 and a controller 13. The machining detecting device 12 is connected to the wire electrode 11 and the controller 13 is connected to the wire electrode 11 and the machining detecting device 12.

In this specific embodiment, the wire electrode 11 is configured to machine a workpiece 5. As shown in FIG. 2 and FIG. 3, the workpiece 5 comprises a bottom surface 51, a top surface 52 and a side surface 53 disposed between the bottom surface 51 and the top surface 52. Wherein, the side surface 53 is the machining surface, and the distance between the bottom surface 51 and the top surface 52 is the workpiece height (Hₕ). In this specific embodiment, the wire electrical discharge machining equipment 1 comprises a fixed electrode head 111 and a movable electrode head 112. The fixed electrode head 111 and the movable electrode 112 are disposed vertically opposite to each other, and the wire electrode 11 is disposed between the fixed electrode head 111 and the movable electrode head 112. The distance between the fixed electrode head 111 and the movable electrode head 112 is the electrode length of the wire electrode 11. Furthermore, the location of the fixed electrode head 111 and the movable electrode head 112 are corresponding to the bottom surface 51 and the top surface 52 of the workpiece 5 respectively. The wire electrode 11 is disposed on the side surface 53 of the workpiece 5 and moves along the direction of the arrow in the figure to machine.

In practice, the fixed electrode head 111 and the movable electrode head 112 can be a wire feeder and a wire reeler. The wire electrode 11 can machine the workpiece 5 through continuous motion of wire feeding and reeling, but it is not limited to this. The fixed electrode head 111 and the movable electrode head 112 can be elements having clamping mechanism to clamp and fix the wire electrode 11. Furthermore, the movable electrode head 112 can vertically move up and down along Z-axis to adjust the distance between the fixed electrode head 111 and the movable electrode head 112, in other words, to adjust the electrode length of the wire electrode 11. The wire electrode 11 and the workpiece 5 can be connected to power supplies with different polarities respectively, and there is a discharge gap between the wire electrode 11 and the workpiece 5. When the wire electrode 11 moves toward the workpiece 5 and enters the discharge gap, the wire electrode 11 can perform electrical discharge and generate sparks. High temperature produced from sparks can erode the workpiece 5 to achieve electrical discharge machining. As shown in FIG. 3, the surface of the workpiece 5 comprises rough cutting residual material T. The wire electrode 11 can move along the direction of the arrow to remove the rough cutting residual material to perform finish machining.

In this specific embodiment, the machining detecting device 12 is configured to detect and obtain a machining parameter set of the wire electrode 11 while machining the workpiece 5. In practice, the machining detecting device 12 can be a signal acquisition chip. The machining detecting device 12 is electrically connected to the wire electrode 11. The machining detecting device 12 can detect the machining status of the wire electrode 11 in real time to obtain the machining parameter between the wire electrode 11 and the workpiece 5. Wherein, the machining parameter set can comprise a discharge frequency, a working voltage and a discharge parameter. Wherein, the discharge parameter can comprise at least one of an arc discharge frequency, a short-circuit discharge frequency, a machining time, a machining coordinates, a machining current, and a wire electrode feed rate.

In this specific embodiment, the wire electrical discharge machining equipment 1 can comprise a database 14 connected to the machining detecting device 12. The database 14 is configured to store the machining parameter set detected and obtained by the machining detecting device 12. In practice, the database 14 can be a hard disk, a portable hard drive, cloud storage, or other data storage device. Furthermore, the database 14 can store a plurality of historical machining parameter sets. The plurality of historical machining parameter sets can be measured through practical use, experiments, or design evaluation. Each of historical machining parameter sets can comprise the aforementioned discharge frequency, a working voltage, a workpiece height and a discharge parameter. The discharge parameter can be corresponding to a material removal amount. Otherwise, the wire electrical discharge machining equipment 1 can further comprise an analysis unit (not shown in the figure) connected to the database 14. The analysis unit is configured to generate a discharge parameter surface model and a wire electrode feed rate surface model using machine learning or algorithms according to the historical machining parameter sets. Moreover, the discharge parameter surface model and the wire electrode feed rate surface model generated by the analysis unit can be stored in the database 14.

In this specific embodiment, the discharge parameter surface model comprises the following equation:

$${H}_{h} = {Z}_{0} + {X}_{B} \times {e}^{- 0.5 {( \frac{ln ( {f}_{Norm} / {X}_{C} )}{{X}_{D}} )}^{2}} + {Y}_{B} \times {e}^{- 0.5 {( \frac{ln ( OV / {Y}_{C} )}{{Y}_{D}} )}^{2}} + {XY}_{H} \times {e}^{- 0.5 ( {( \frac{ln ( {f}_{Norm} / {X}_{C} )}{{X}_{D}} )}^{2} + {( \frac{ln ( OV / {Y}_{C} )}{{Y}_{D}} )}^{2} )}$$

Wherein, Hₕ is the workpiece height, f_{Norm} is the discharge frequency, OV is the working voltage, Z₀,X_{B},X_{C},X_{D},Y_{B},Y_{C},Y_{D} and X_{YH} are constants.

The wire electrode feed rate surface model comprises the following equation:

$$F = {F}_{z 0} + {F}_{XY} \times {e}^{( \frac{- {H}_{h}}{{F}_{XC}} )} \times {e}^{( \frac{- SR}{{F}_{YC}} )}$$

Wherein, F is a machining feed rate, SR is the material removal amount, F_{z0},F_{XY},F_{XC} and F_{YC} are constants.

In this specific embodiment, the controller 13 is connected to the wire electrode 11, the machining detecting device 12 and the database 14. The controller 13 is configured to compute the workpiece height of workpiece 5 according to the discharge frequency, the working voltage and the discharge parameter surface model detected by the machining detecting device 12. Moreover, the controller 13 is configured to compute the machining feed rate according to the material removal amount, the workpiece height and the wire electrode feed rate surface model, which is corresponding to the discharge parameter detected by the machining detecting device. In practice, the machining detecting device 12 can continuously obtain and update the machining parameter set when the wire electrode 11 machines the workpiece 5. The controller 13 can compute the current workpiece height of the workpiece 5 according to the latest discharge frequency and the working voltage. Then, the controller 13 can obtain the current rough cutting residual material according to the material removal amount, which is corresponding to the latest discharge frequency, to compute an appropriate machining feed rate. Furthermore, the controller 13 can be connected to and control the movable electrode head 112. The controller 13 can adjust the movable electrode head 112 according to the workpiece height, and adjust the electrode length of the wire electrode 11 to the workpiece height to machine the workpiece 5 when the controller 13 computes the workpiece height of the workpiece 5 according to the discharge frequency, the working voltage and the discharge parameter surface model detected by the machining detecting device 12.

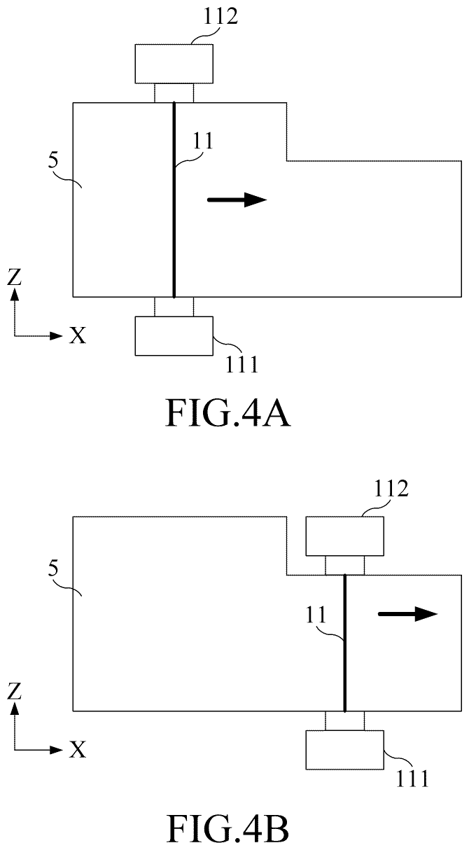

Please refer to FIG. 1, FIG. 4A and FIG. 4B. FIG. 4A is a structural diagram illustrating that the wire electrode machines the workpiece at the first location according to an embodiment of the present invention. FIG. 4B is a structural diagram from another perspective illustrating that the wire electrode machines the workpiece at the second location of FIG. 4A. As shown in FIG. 4A, the machining detecting device 12 can obtain the discharge frequency (f_{Norm}1), the working voltage (OV1) and the discharge parameter (P1) of the wire electrode 11 when the wire electrode 11 machines the workpiece 5 at the first location. At this time, the controller 13 can compute the workpiece height (Hₕ1) of the workpiece according to the discharge frequency (f_{Norm}1), the working voltage (OV1) and the discharge parameter surface model stored in the database 14. The controller 13 drives the movement of the movable electrode head 112 to adjust the electrode length of the wire electrode 11 to the workpiece height (Hₕ1). Then, the controller 13 can determine the corresponding material removal amount (SR1) according to the discharge parameters (P1). The controller 13 computes the machining feed rate (F1) according to the workpiece height (Hₕ1), the material removal amount (SR1) and the wire electrode feed rate surface model. Finally, the controller 13 can drive the wire electrode 11 to machine the workpiece 5 with the machining feed rate (F1).

As shown in FIG. 4B, the discharge frequency of the wire electrode 11 changes as the workpiece height changes when the wire electrode 11 machines the workpiece 5 at the second location. At this time, the machining detecting device 12 can obtain the discharge frequency (f_{Norm}2), the working voltage (OV2) and the discharge parameter (P2) of the wire electrode 11 in real time. Then, the controller 13 can compute the workpiece height (Hₕ2) according to the discharge frequency (f_{Norm}2), the working voltage (OV2) and the discharge parameter surface model. The controller 13 drives the movement of the movable electrode head 112, thereby adjusting the electrode length of the wire electrode 11 to the workpiece height (Hₕ2). Subsequently, the controller 13 can determine the corresponding material removal amount (SR2) according to the discharge parameter and compute the machining feed rate (F2) according to the workpiece height (Hₕ2), the material removal amount (SR2) and the wire electrode feed rate surface model. Finally, the controller 13 drives the wire electrode 11 to machine the workpiece 5 with the machining feed rate. In this specific embodiment, the shape of the top surface 52 of the workpiece 5 is a stepped surface, but it is not limited to this in practice. The shape of the top surface can also be a flat surface, an inclined surface and a curved surface.

In this specific embodiment, it is worth noting that the workpiece height of the workpiece 5 and the rough cutting residual material machined on the workpiece 5 have changed. Therefore, the controller 13 can re-compute the workpiece height and the machining feed rate, but it is not limited to this in practice. In one specific embodiment, the overall workpiece heights of the workpiece are approximately the same, but it comprises different rough cutting residual materials at different locations. At this time, the machining detecting device can obtain the machining parameter set comprising the same discharge frequency and working voltage and the plurality of discharge parameters. The controller can fix the electrode length of the wire electrode and adjust the machining feed rate according to different machining locations. In another specific embodiment, the rough cutting residual materials on the workpiece are approximately the same, while the workpiece has different workpiece heights at different locations. At this time, the machining detecting device can obtain the machining parameter set comprising the same discharge frequency, and the plurality of different discharge parameters and working voltages. The controller can fix the machining feed rate and adjust the electrode length of the wire electrode according to the different machining locations when the wire electrode machines the workpiece.

Therefore, the invention of the wire electrical discharge machining equipment can detect the machining parameter of the electrode according to the machining detecting device in real time. In addition, the wire electrical discharge machining equipment can automatically detect the workpiece height of the workpiece through the discharge parameter surface model. The wire electrical discharge machining equipment can automatically adjust the machining feed rate to the correct machining feed rate through the wire electrode feed rate surface model and receive real-time feedback to adjust the wire electrode length and the machining feed rate. Moreover, the wire electrical discharge machining equipment can remove the rough cutting residual materials from workpieces with different heights to increase machining accuracy and machining efficiency and improve stability and machining quality.

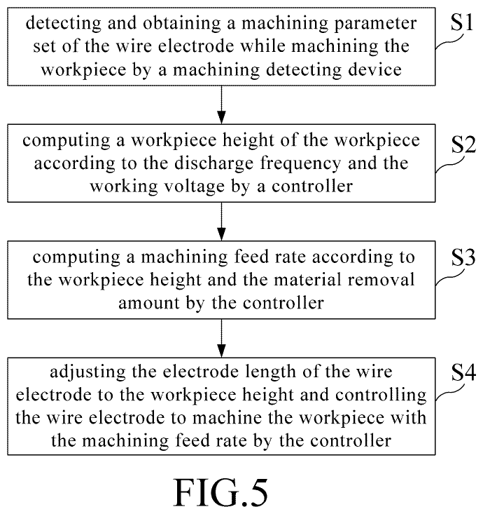

Please refer to FIG. 5. FIG. 5 is a flowchart illustrating the method for wire electrical discharge machining according to an embodiment of the present invention. The steps illustrated in FIG. 5 can be carried out by the wire electrical discharge machining equipment shown in FIG. 1. As shown in FIG. 5, in this specific embodiment, the method for wire electrical discharge machining further comprises the following steps of: Step S1: detecting and obtaining a machining parameter set of the wire electrode 11 while machining the workpiece 5 by a machining detecting device 12, wherein the machining parameter set comprises a discharge frequency, a working voltage and a discharge parameter, and the discharge parameter is corresponding to a material removal amount; Step S2: computing a workpiece height of the workpiece according to the discharge frequency and the working voltage by a controller 13; Step S3: computing a machining feed rate according to the workpiece height and the material removal amount by the controller 13; and Step S4: adjusting the electrode length of the wire electrode 11 to the workpiece height and controlling the wire electrode 11 to machine the workpiece 5 with the machining feed rate by the controller 13. In practice, in Step S2, the controller 13 can compute the workpiece height of the workpiece 5 according to the discharge frequency, the working voltage and the equation of the aforementioned discharge parameter surface model. Furthermore, in Step S3, the controller 13 can compute the machining feed rate according to the workpiece height, the material removal amount and the equation of the aforementioned wire electrode feed rate surface model.

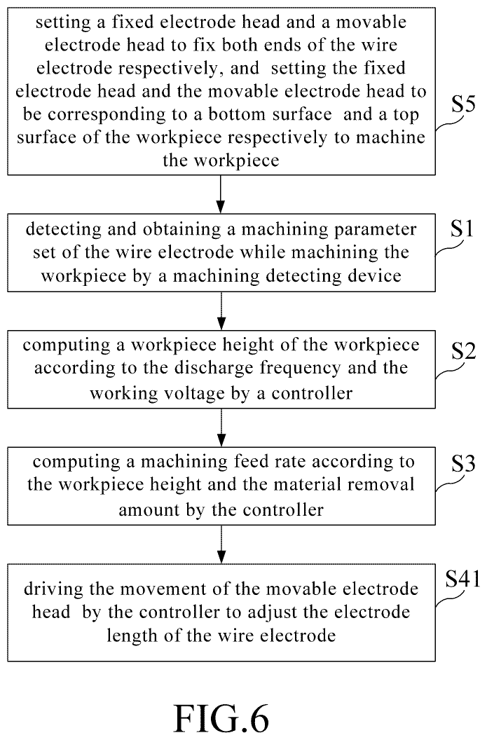

Please refer to FIG. 6. FIG. 6 is a flowchart illustrating the method for wire electrical discharge machining according to an embodiment of the present invention. The steps illustrated in FIG. 6 can be carried out by the wire electrical discharge machining equipment shown in FIG. 1 and they are further steps of FIG. 5. As shown in FIG. 6, the method for wire electrical discharge machining further comprises the following steps of: Step S5: setting a fixed electrode head 111 and a movable electrode head 112 to fix both ends of the wire electrode 11 respectively, and setting the fixed electrode head 111 and the movable electrode head 112 to be corresponding to a bottom surface 51 and a top surface 52 of the workpiece 5 respectively to machine the workpiece 5. Wherein, the step of adjusting the electrode length of the wire electrode shown in Step S4 of FIG. 5 further comprises the step of: Step S41: driving the movement of the movable electrode head 112 by the controller 13 to adjust the electrode length of the wire electrode 11.

In summary, the invention of the wire electrical discharge machining equipment can detect the machining parameter of the electrode in real time according to the machining detecting device and automatically detect the workpiece height of the workpiece through a discharge parameter surface model. In addition, the invention of the wire electrical discharge machining equipment can automatically adjust the machining feed rate to the correct machining feed rate through a wire electrode feed rate surface model and receive real-time feedback to adjust the wire electrode length and the machining feed rate. Moreover, the wire electrical discharge machining equipment can remove the rough cutting residual materials from workpieces with different heights to increase machining accuracy and machining efficiency and improve stability and machining quality.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A wire electrical discharge machining equipment for different workpiece heights, comprising:
a wire electrode having an electrode length and configured to machine a workpiece;
a machining detecting device configured to detect and obtain a machining parameter set of the wire electrode while machining the workpiece, wherein the machining parameter set comprises a discharge frequency, a working voltage and a discharge parameter, and the discharge parameter is corresponding to a material removal amount; and
a controller connected to the wire electrode and the machining detecting device, the controller being configured to compute a workpiece height of the workpiece according to the discharge frequency and the working voltage, and compute a machining feed rate according to the workpiece height and the material removal amount, the controller being configured to adjust the electrode length to the workpiece height and control the wire electrode to machine the workpiece with the machining feed rate.

2. The wire electrical discharge machining equipment of claim 1, wherein the controller computes the workpiece height according to the following equation:
$${H}_{h} = {Z}_{0} + {X}_{B} \times {e}^{- 0.5 {( \frac{ln ( {f}_{Norm} / {X}_{C} )}{{X}_{D}} )}^{2}} + {Y}_{B} \times {e}^{- 0.5 {( \frac{ln ( OV / {Y}_{C} )}{{Y}_{D}} )}^{2}} + {XY}_{H} \times {e}^{- 0.5 ( {( \frac{ln ( {f}_{Norm} / {X}_{C} )}{{X}_{D}} )}^{2} + {( \frac{ln ( OV / {Y}_{C} )}{{Y}_{D}} )}^{2} )}$$
wherein, Hₕ is the workpiece height, f_{Norm} is the discharge frequency, OV is the working voltage, Z₀,X_{B},X_{C},X_{D},Y_{B},Y_{C},Y_{D} and XY_{H} are constants.

3. The wire electrical discharge machining equipment of claim 1, wherein the controller computes the machining feed rate according to the following equation:
$$F = {F}_{z 0} + {F}_{XY} \times {e}^{( \frac{- {H}_{h}}{{F}_{XC}} )} \times {e}^{( \frac{- SR}{{F}_{YC}} )}$$
wherein, F is the machining feed rate, SR is the material removal amount, F_{z0},F_{XY},F_{XC} and F_{YC} are constants.

4. The wire electrical discharge machining equipment of claim 1, further comprising a fixed electrode head and a movable electrode head for fixing both ends of the wire electrode respectively and being connected to the controller, and the controller being configured to drive the movable electrode head to adjust the electrode length of the wire electrode.

5. The wire electrical discharge machining equipment of claim 4, wherein the workpiece has a bottom surface and a top surface, the location of the fixed electrode head and the movable electrode head are corresponding to the bottom surface and the top surface respectively, and the shape of the top surface is at least one of a flat surface, an inclined surface, a curved surface and a stepped surface.

6. A method for wire electrical discharge machining applied to different workpiece heights, comprising the following steps of:
detecting and obtaining a machining parameter set of the wire electrode during machining the workpiece by a machining detecting device, wherein the machining parameter set comprises a discharge frequency, a working voltage and a discharge parameter, and the discharge parameter is corresponding to a material removal amount;
computing a workpiece height of the workpiece according to the discharge frequency and the working voltage by a controller;
computing a machining feed rate according to the workpiece height and the material removal amount by the controller; and
adjusting the electrode length to the workpiece height and controlling the wire electrode to machine the workpiece with the machining feed rate by the controller.

7. The method for wire electrical discharge machining of claim 6, wherein the controller in the step of computing the workpiece height of the workpiece according to the discharge frequency and the working voltage by the controller computes the workpiece height according to the following equation:
$${H}_{h} = {Z}_{0} + {X}_{B} \times {e}^{- 0.5 {( \frac{ln ( {f}_{Norm} / {X}_{C} )}{{X}_{D}} )}^{2}} + {Y}_{B} \times {e}^{- 0.5 {( \frac{ln ( OV / {Y}_{C} )}{{Y}_{D}} )}^{2}} + {XY}_{H} \times {e}^{- 0.5 ( {( \frac{ln ( {f}_{Norm} / {X}_{C} )}{{X}_{D}} )}^{2} + {( \frac{ln ( OV / {Y}_{C} )}{{Y}_{D}} )}^{2} )}$$
wherein, Hₕ is the workpiece height, f_{Norm} is the discharge frequency, OV is the working voltage, Z₀,X_{B},X_{C},X_{D},Y_{B},Y_{C}, Y_{D} and XY_{H} are constants.

8. The method for wire electrical discharge machining of claim 6, wherein the controller in the step of computing the machining feed rate according to the workpiece height and the material removal amount by the controller computes the machining feed rate according to the following equation:
$$F = {F}_{z 0} + {F}_{XY} \times {e}^{( \frac{- {H}_{h}}{{F}_{XC}} )} \times {e}^{( \frac{- SR}{{F}_{YC}} )}$$
wherein, F is the machining feed rate, SR is the material removal amount, F_{z0},F_{XY},F_{XC} and F_{YC} are constants.

9. The method for wire electrical discharge machining of claim 6, further comprising the steps of:
setting a fixed electrode head and a movable electrode head to fix both ends of the wire electrode respectively, and setting the fixed electrode head and the movable electrode head to be corresponding to a bottom surface and a top surface respectively to machine the workpiece;
wherein, the step of adjusting the electrode length of the wire electrode further comprises the step of:
driving the movement of the movable electrode head by the controller to adjust the electrode length of the wire electrode.

10. The method for wire electrical discharge machining of claim 9, wherein the shape of the top surface is at least one of a flat surface, an inclined surface, a curved surface and a stepped surface.
